(19) United States
(12) Patent Application Publication
(10) Pub. No.: US 2026/0340984 A1
(43) Pub. Date: Oct. 29, 2026

(54) SYSTEMS AND METHODS OF IMAGE PROCESSING FOR SWATCH GENERATION FOR ITEMS

(71) Applicant: Walmart Apollo, LLC, Bentonville, AR (US)

(72) Inventors: Yi-Sheng Yang, San Jose, CA (US); Shreyansh P. Gandhi, Milpitas, CA (US); Ishan V. Bhatt, Fremont, CA (US); Lina Jin, San Jose, CA (US); Quoc T. Tran, Los Altos, CA (US)

(21) Appl. No.: 19/193,465

(22) Filed: Apr. 29, 2025

(51) Int. Cl. G06V 10/74; G06V 10/25; G06V 10/26; G06V 10/56; G06V 10/762

(52) U.S. Cl. CPC G06V 10/761; G06V 10/25; G06V 10/26; G06V 10/56; G06V 10/762

(57) ABSTRACT

In some embodiments, apparatuses and methods are provided herein useful to process images for swatch generation. In some embodiments, a system may include a database storing data associated with a plurality of items, a processing resource, and a machine readable medium storing instructions that, when executed, cause the processing resource to: segment an image associated with an item of the plurality of items into a plurality of regions; identify a region of the plurality of regions having a region color similar to a color associated with the item; generate a plurality of patches from the identified region of the image; select a patch of the plurality of patches based on homogeneity of a plurality of pixels and on a similarity to the color stored in the database associated with the item relative to other patches; and assign the selected patch as a swatch to associate with the item.

### TECHNICAL FIELD

This invention relates generally to images of items and more specifically to swatches for the items.

### BACKGROUND

Many e-commerce platforms (e.g., websites and/or applications associated with a retailer) utilize cropped image segments to preview variations (e.g., colors and/or patterns) of an item to a user. The cropped segments, also referred to as swatches, may be previewed on an item listing page such that a user is not required to view an item specific page in order to view available variations of the item. Currently, swatch generation systems rely on manual cropping of an image to generate a swatch which can be slow, costly, and difficult to scale. Color blocks are alternately used to preview item variations, and resulting swatches may be limited in terms of color accuracy, depiction of materials, and depiction of patterns.

### BRIEF DESCRIPTION OF DRAWINGS

Disclosed herein are embodiments of systems, apparatuses and methods pertaining to image processing for swatch generation for items. This description includes drawings, wherein:

FIG. 1 is a block diagram of a swatch generation system in accordance with some embodiments;

FIG. 2A is block diagram of a swatch generation process in accordance with some embodiments;

FIG. 2B is an example of the swatch generation process of FIG. 2A in accordance with some embodiments;

FIG. 3A is a block diagram of a swatch generation process in accordance with some embodiments;

FIG. 3B is an example of the swatch generation process of FIG. 3A in accordance with some embodiments;

FIG. 4A is a block diagram of a pre-processing process within a swatch generation process in accordance with some embodiments;

FIG. 4B is an example of the pre-processing process of FIG. 4A in accordance with some embodiments;

FIG. 5A is a block diagram of a color value process within a swatch generation process in accordance with some embodiments;

FIG. 5B is an example of the color value process of FIG. 5A in accordance with some embodiments;

FIG. 6A is a block diagram of a swatch selection process of a swatch generation process in accordance with some embodiments;

FIG. 6B is an example of the swatch selection process of FIG. 6A in accordance with some embodiments;

FIG. 7A is a block diagram of an alternate swatch generation process relative to a swatch generation process in accordance with some embodiments;

FIG. 7B is an example of the alternate swatch generation process of FIG. 7A in accordance with some embodiments;

FIG. 8 is a block diagram of a swatch generation system in accordance with some embodiments;

FIG. 9A is a flow diagram showing a method of swatch generation in accordance with some embodiments; and

FIG. 9B is a flow diagram showing a method of swatch generation in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to image processing for swatch generation for items. In some embodiments, a system includes: a database storing data associated with a plurality of items, the data including one or more colors associated with at least some of the plurality of items, a processing resource, and a machine readable medium storing instructions. The instructions, when executed by the processing resource, cause the processing resource to: segment an image associated with an item of the plurality of items into a plurality of regions; identify a region of the plurality of regions having a region color similar to a color stored in the database associated with the item; generate a plurality of patches from the identified region of the image; select a patch of the plurality of patches based on homogeneity of a plurality of pixels and on a similarity to the color stored in the database associated with the item relative to other patches of the plurality of patches; and assign the selected patch as a swatch to associate with the item.

In some embodiments, a method includes: segmenting, an image associated with an item of a plurality of items into a plurality of regions, where data associated with the plurality of items is stored in a database, the data including one or more colors associated with at least some of the plurality of items; identifying a region of the plurality of regions having a region color similar to a color stored in the database associated with the item; generating a plurality of patches from the identified region of the image; selecting a patch of the plurality of patches based on homogeneity of a plurality of pixels and on a similarity to the color stored in the database associated with the item relative to other patches of the plurality of patches; and assigning the selected patch as a swatch to associate with the item.

In some embodiments, a non-transitory machine readable medium storing instructions for a system, when executed, cause a processing resource to: segment an image associated with an item of a plurality of items into a plurality of regions, where data associated with the plurality of items is stored in a database, the data including one or more colors associated with at least some of the plurality of items; identify a region of the plurality of regions having a region color similar to a color stored in the database associated with the item; generate a plurality of patches from the identified region of the image; select a patch of the plurality of patches based on homogeneity of a plurality of pixels and on a similarity to the color stored in the database associated with the item relative to other patches of the plurality of patches; and assign the selected patch as a swatch to associate with the item.

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

Conventional network platforms, such as e-commerce platforms, may have sub-optimal swatch generation systems that rely on manual processes to generate swatches. Manual processes are generally costly, timely, and are difficult to scale. Additionally, conventional platforms may utilize processes which generate sub-optimal swatches for items (e.g., inaccurate color, no materials, no pattern, etc.). The present disclosure describes embodiments of systems and methods which automate swatch generation for items. In some embodiments, a scalable system is described which uses available color information to automatically extract swatches across various item types. In some embodiments, the system is able to capture a target item within an image despite backgrounds, other objects, people, and so forth. Alternatively, or in addition, in some embodiments, the system follows an alternate swatch extraction process to generate a swatch. In some embodiments, the alternate swatch extraction process is executed when color information is not available, or swatch extraction is unsuccessful. In some embodiments, automation of swatch generation may result in improvements to time required to generate swatches, accuracy of swatches generated, and may overall improve user engagements on a platform which displays the swatches.

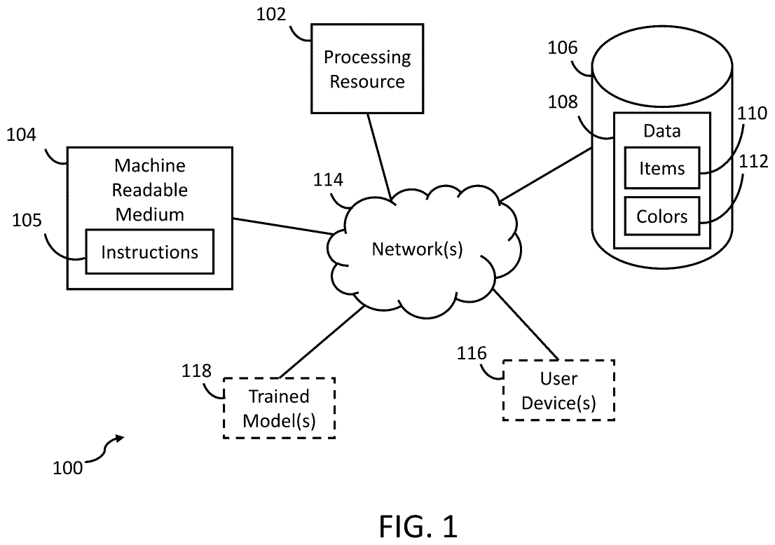

FIG. 1 shows a system 100 for swatch generation in accordance with some embodiments. The system 100 includes at least one processing resource 102, at least one machine readable medium 104 storing instructions 105, and at least one database 106 communicatively coupled over a network 114. In some embodiments, one or more user devices 116 and/or one or more trained models 118 may further be communicatively coupled to each other over the network 114. Generally, and in some embodiments, the system 100 generates swatches from data 108 associated with one or more items 110, at least some of the items 110 being associated with one or more colors 112. Generally, and in some embodiments, the system 100 generates a swatch from an image associated with one of the items 110 using a first swatch generation process. In some embodiments, a swatch may be generated using the first swatch generation process when a color 112 associated with the item 110 is available in the database 106. Alternatively, or in addition, the system 100 generates a swatch from the image associated with the item 110 using an alternate swatch generation process when the color 112 associated with the item 110 is not available in the database 106 or swatch extraction using the first swatch generation process is unsuccessful.

The database(s) 106 may be any suitable databases (e.g., hierarchical databases, relational databases, non-relational databases, object oriented databases, and so forth) configured to store data relevant to the system 100. In some embodiments, data stored in the database(s) 106 includes data 108 (e.g., images, text, metadata, embeddings, etc.) associated with a plurality of items 110 for sale. In some embodiments, the data 108 includes colors 112 associated with the items 110 that indicate an expected color of the item 110 found within data associated with the item 110 (e.g., an item description). Any suitable data relevant to the systems and processes described herein may be stored in one or more databases 106.

The processing resource(s) 102 may include any suitable processing resource configured to execute instructions stored in a computer-readable storage memory (e.g., random access memory, read-only memory, hard disk drive, solid-state drive, optical disc, storage network, network-attached storage, storage area network, and/or any non-transitory, computer-readable storage medium). In this context, the term processing resource 102 (may alternatively be referred to as a control circuit and/or a controller) may refer broadly to any microcontroller, computer, or processor-based device with processor, memory, and programmable input/output peripherals, which is generally designed to govern the operation of other components and devices. In some embodiments, the processing resource 102 may be operatively coupled to common accompanying accessory devices, including memory, transceivers for communication with other components and devices, etc. The common accompanying accessory devices, including memory, transceivers for communication with other components and devices are architectural options that are well known and understood in the art and require no further description here. The processing resource 102 may be configured to carry out one or more of the steps, actions, and/or functions described herein.

In some aspects, instructions 105 executable by the processing resource 102 are stored in a computer readable storage memory (e.g., the machine readable medium 104). The machine readable medium(s) 104 may store any additional data relevant to the system 100 (e.g., data 108, training data, previously generated swatches, and the like). Examples of suitable machine readable mediums 104 includes random access memory (RAM), read-only memory (ROM), erasable programmable read-only memory (EPROM/flash memory), and so forth, and include non-transient mediums. The machine readable medium 104 typically includes one or more processor-readable and/or computer-readable media accessed by at least the processing resource 102, and can include volatile and/or nonvolatile media, such as RAM, ROM, EEPROM, flash memory and/or other memory technology. The machine readable medium 104 memory can be external (as shown in FIG. 1), internal, or a combination of internal and external memory of the processing resource 102.

The network 114 may be any suitable network or communication method such as, for example, a local area network (LAN), the Internet, wide area network (WAN), etc., communication link, other networks or communication channels with other devices and/or other such communications (not shown) or combination of two or more of such communication methods. There may be any combination of wired connections and/or wireless connections (e.g., Wi-Fi, Bluetooth, cellular, RF, and/or other such wireless communication) between elements of the system 100.

The user device(s) 116 may be operatively coupled to the any described components of the system 100 and may include, but are not limited to, smartphones, tablets, laptops, computers, and/or other such electronic devices and/or computing systems that enable a user to communicate with the system 100. In some aspects, one or more user devices 116 may be part of the system 100 and/or one or more user devices 116 may be separate and distinct from the system 100. In some embodiments, the user device(s) 116 can allow a user to interact with the system 100 and receive information through the system 100. In some instances, the user device 116 includes a display and/or one or more user inputs, such as buttons, touch screen, track ball, keyboard, mouse, etc., which can be part of or wired or wirelessly coupled with the system 100. In some aspects, the user device(s) 116 is a mobile device. Exemplary mobile devices may include, but are not limited to, cellular telephones, smartphones, tablets, portable computers, laptop computers, personal digital assistants, wearable devices, watches, eyeglasses, goggles, media players vehicle displays, and the like.

The trained model(s) 118 may be language models trained using any suitable machine learning algorithm(s) including decision trees, random forest, neural networks, deep learning, k-means and so forth. The trained model(s) 118 may be operatively coupled with the processing resource 102 via the network 114, and the processing resource 102 may execute the trained model(s) 118. In some embodiments, instructions stored in memory (e.g., of the processing resource 102 and/or external memory) may cause the processing resource 102 to output information and/or data from the user device(s) 116, the database(s) 106, and/or the machine readable medium(s) 104 to be used by the trained model(s) 118. In some embodiments, the instructions may be in part include the trained model 118. The trained model 118 is generally pre-trained with data, and in some embodiments may be re-trained by any combination of manually input re-training data and/or self-learning methods. In some embodiments, the trained model(s) 118 are large language models (LLMs). In some embodiments, example LLMs include: GPT-4 and ChatGPT from OpenAI; BERT, T5, Bard from Google; Claude 3.5; Llama from Meta; and Bing Chat from Microsoft. In some embodiments, the LLMs may be trained by third parties and reside and be executed in a third party cloud server environment. In some embodiments, the trained models 118 may be downloaded from third parties and trained using data specific to the system 100 and executed on server(s) controlled by the system 100 developer.

The trained model(s) 118, in some embodiments, are machine learning agents (e.g., LLM agents) which execute the functions described herein. For example, the trained models 118 may be systems built on top of a machine learning model that may interact with external tools and application programming interfaces (APIs). In other words, a machine learning agent can use external tools to perform actions beyond text generation (e.g., utilizing search engines on the internet). A machine learning agent may further maintain a state and/or context across multiple steps by calling a machine learning model multiple times and recalling the input(s) and/or output(s) of each call. In other words, a machine learning agent utilizes machine learning models along with additional tools (e.g., open source resources, search engines, additional models, etc.) in order to complete tasks. In some embodiments, the trained models 118 described herein are machine learning agents communicating with additional machine learning models.

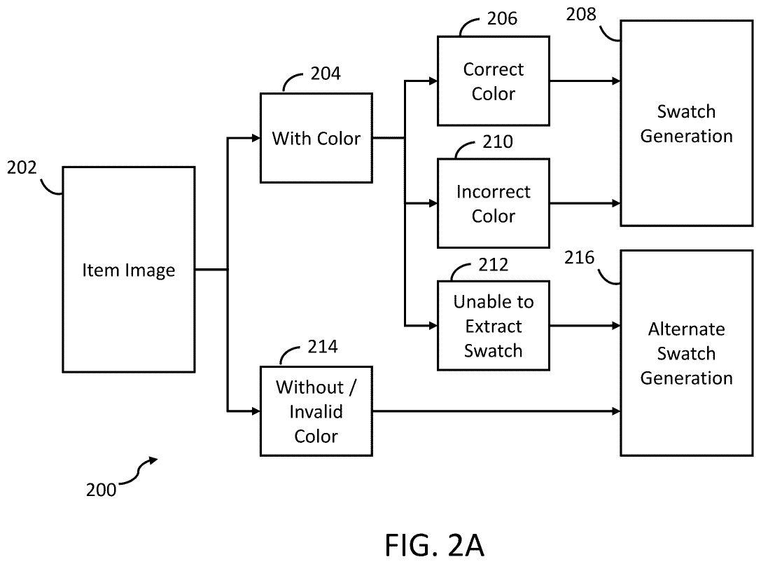

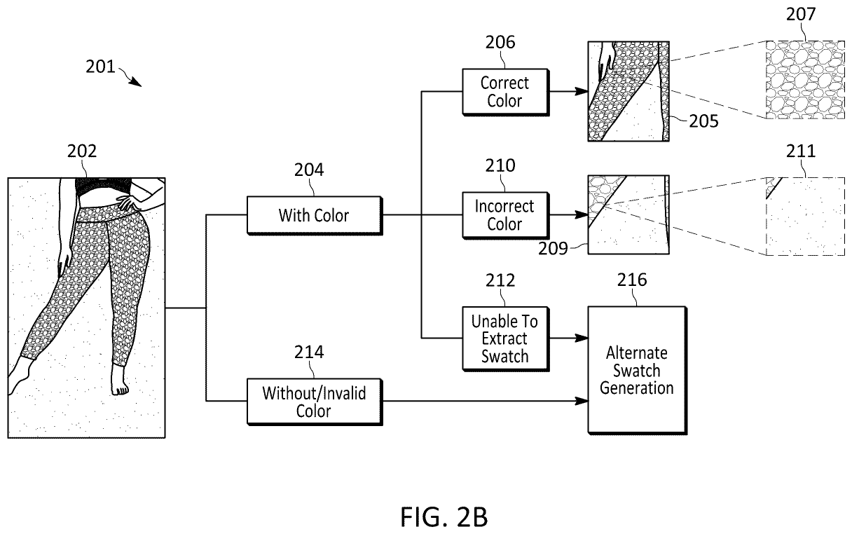

Further referring to FIGS. 2A and 2B, a process 200 for item swatch generation is shown in accordance with some embodiments. It is generally contemplated that the system 100 may execute the process 200. Specifically, the processing resource 102 may perform steps of the process 200. In some embodiments, the process 200 begins by retrieving an item image 202. At block 204, the system 100 determines that there is a color (such as the color 112) associated with the item (such as the item 110) in the item image 202. In some embodiments, when the color associated with the item in the item image 202 is a correct color 206 for the item, a swatch generation process 208 occurs. In some embodiments, when the color associated with the item in the item image 202 is an incorrect color 210 for the item (e.g., the associated color stored in the database 106 with the item was in error), the swatch generation process 208 may occur. In other words, when there is a color associated with the item in the item image 202 available (whether it is the correct color 206 or the incorrect color 210), the swatch generation process 208 occurs. In some embodiments, after generation of a swatch, the swatch may be reviewed (automatically and/or manually) in order to determine if the swatch contains the item (for example, when the correct color 206 is provided or stored in the database 106) or if the swatch does not contain the item (for example, when the incorrect color 210 is provided or stored in the database 106). In some embodiments, when it is determined that an incorrect color 210 is utilized during swatch generation, the color may be updated (automatically and/or by a user) and the swatch may be regenerated. In some embodiments, the database 106 may store a listing of valid color names. In such embodiments, to determine whether the associated color stored in the database 106 for the item in the item image 202 is a correct color 206 or an incorrect color 210, the processing resource 102 may compare the associated color with the color names in the listing. If there is a match, the associated color corresponds to the correct color 206. If there is not a match, the associated color corresponds to the incorrect color 210. In some embodiments, the listing of valid color names comprises color names that are correctly spelled and various incorrect spelling of the correctly spelled color names. For example, “green” is the correct spelling for the color. The various incorrect spelling of the color “green” may include “gren”, “gran”, “gen”, to name a few. Another example is the color “red”. The various incorrect spelling of the color “red” may include “rad”, “rd”, “ed”, to name a few. In some embodiments, the listing may include association of the correctly spelled color names with one or more incorrect spelling of the correctly spelled color names.

In some aspects, when a swatch is unable to be extracted (such as at block 212), an alternate swatch generation process 216 occurs. For example, at block 214, if the system 100 determines that there is not a color associated with the item in the item image 202, or that the color associated with the item in the item image 202 is invalid (e.g., the color associated with the item is not a known/recognized color or a null data), the alternate swatch generation process 216 occurs. In other words, if there is not a valid color associated with the item in the item image 202 available and/or if the swatch generation process 208 was unsuccessful, the alternate swatch generation process 216 may be performed. In some embodiments, the processing resource 102 may access the database 106 to retrieve data corresponding to one or more colors associated with the item. In some embodiments, the data retrieved is invalid data, such that the retrieved data may not correspond to a generally known color, may correspond to a null data (or blank), and/or an erroneously stored color associated with the item.

Further referring to FIG. 2B, an example 201 of the process 200 is shown in accordance with some embodiments. In the shown embodiment, the item in the item image 202 is a pair of blue patterned pants being worn by a model. When the correct color 206 is provided, a cropped image 205 is taken from the item image 202 which centers the cropped image 205 to primarily contain the portion of the item image 202 which includes the correct color 206. In the present example, the correct color 206 provided is blue (for example, provided in textual data associated with the item, such as the color associated with the item stored in the database 106), and the blue portion of the item (shown as cross hatching) is centered in the cropped image 205. The correct swatch 207 primarily includes the item in the item image 202. When the incorrect color 210 is provided, a cropped image 209 is taken from the item image 202 which centers the cropped image 209 to primarily contain the portion of the item image 202 which includes the incorrect color 210. In the present example, the incorrect color 210 provided is yellow (for example, provided in textual data associated with the item, such as the color associated with the item stored in the database 106), and the portion of the item closest to the provided color yellow (such as the light tan portion of the image represented by cross hatching) is centered in the cropped image 209. The incorrect swatch 211 includes a portion of the item image 202 which primarily contains the incorrect color 210 and not the item. In some embodiments, when no swatch is able to be generated and/or no color information or invalid color information is provided, the alternate swatch generation process 216 is followed. In some embodiments, the alternate swatch generation process 216 may be executed regardless of whether a valid or invalid color is provided.

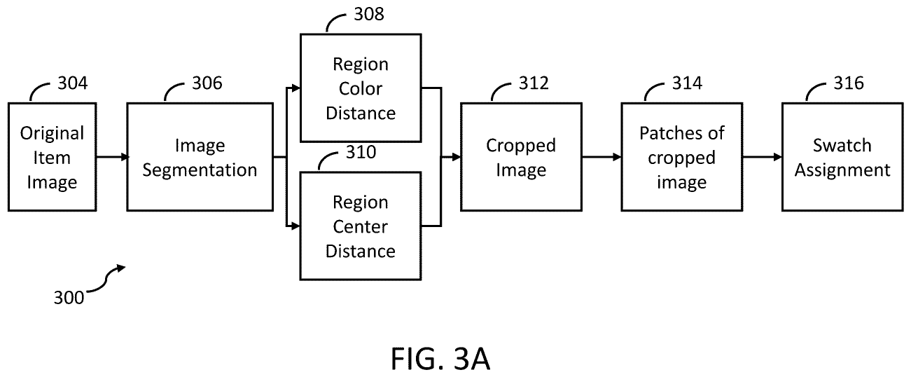

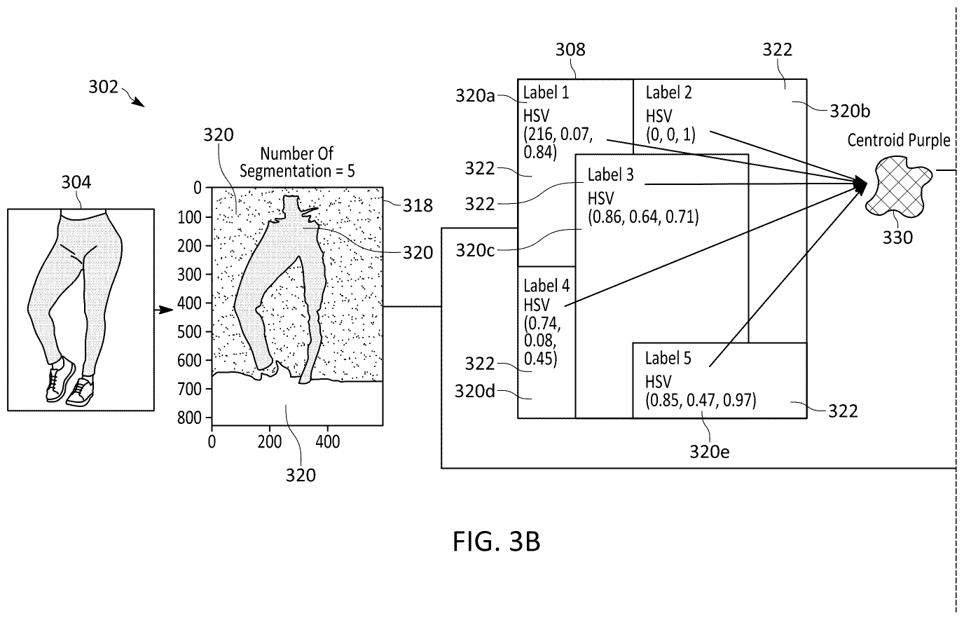

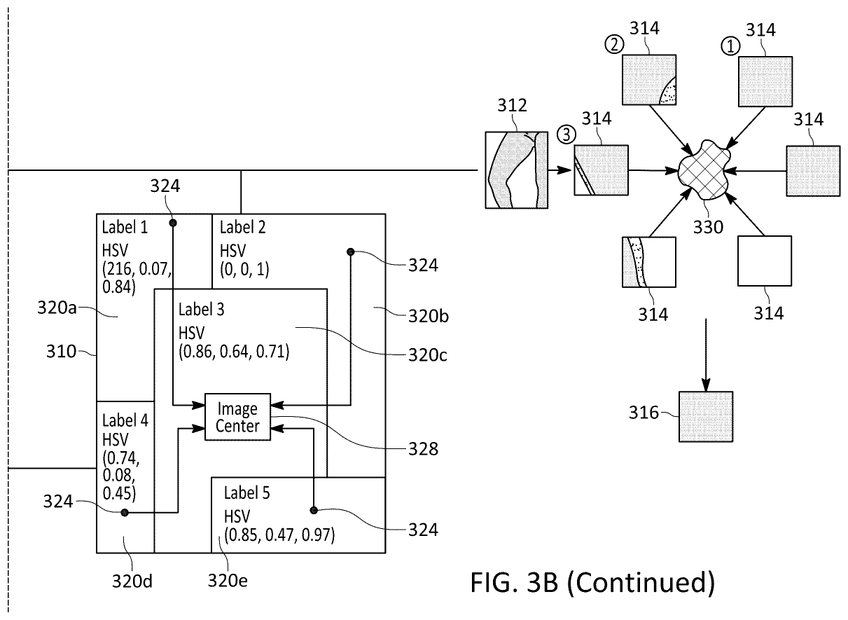

Further referring to FIGS. 3A and 3B, a process 300 for swatch generation is shown in accordance with some embodiments. In some embodiments, the process 300 is the swatch generation process 208 from FIG. 2A. In other words, the process 300 is generally executed when there is a color associated with the item in the image (e.g., the item image 202) available. In some embodiments, it is generally contemplated that the process 300 may be executed by the system 100. For example, the processing resource 102 may perform some or all of the steps of the process 300 described herein. In some embodiments, the process 300 begins by retrieving an original item image 304 (which may be the same or similar to the item image 202) associated with an item (e.g., an item 110). In some aspects, the original item image 304 then undergoes image segmentation 306 such that the original item image 304 is segmented into multiple regions. In some embodiments, the original item image 304 is segmented using a machine learning model (e.g., the trained model(s) 118).

Following image segmentation 306, a region color of each of the regions is identified, and a region color distance 308 and a region center distance 310 for each region is determined. While the region color distance 308 and the region center distance 310 are shown to be determined concurrently, it is contemplated that the region color distance 308 and the region center distance 310 may be determined independently. In some aspects, a region is then identified as having a region color similar to a color associated with the item in the original item image 304. In some embodiments, after identification of the region, the identified region is cropped from the original item image 304 resulting in a cropped image 312. It is generally contemplated that the cropped image 312 may be cropped from the original item image 304 using the region center distance 310. In some embodiments, the process 300 may not require cropping the original item image 304. In some embodiments, the process 300 may not include determining the region center distance 310. As shown, after the region is identified, patches 314 are generated from the cropped image 312. In embodiments where the original item image 304 is not cropped, the patches 314 may be generated from the identified region of the original item image 304 based at least in part on the determined region center distance 310 of the identified region. From the generated plurality of patches 314, a single patch 314 is chosen and assigned as a swatch 316. In some embodiments, the assigned swatch 316 is stored and associated with the item in the database 106, such that whenever the item is shown or presented in an eCommerce platform, the assigned swatch 316 is presented or shown along with the item.

In some embodiments, after assignment of the swatch 316, the swatch 316 is output for display on a user device (e.g., user device 116). The swatch 316 may be displayed on the user device via a platform (e.g., a website and/or application) in association with the item. For example, a listing page may preview one or more item images proximate one or more swatches 316 for each item. A swatch 316 may preview one or more of color, texture, pattern, etc., options available for an item.

Further referring to FIG. 3B, an example 302 of the process 300 is shown in accordance with some embodiments. In the present embodiment, the item in the original item image 304 is a pair of purple pants on a model, the color purple being represented by cross hatching. During image segmentation 306, a segmented image 318 is generated. The segmented image 318 has an x-axis ranging (from left to right) from 0 to 400 number of pixels and a y-axis ranging (from bottom to top) from 800 to 0 number of pixels. The segmented image 318 generally includes a plurality of regions 320, each having a distinct color. The regions 320 may have any suitable size and/or shape, however, the regions 320 generally are configured in response to the shape of distinct areas of color within the original item image 304. In the present example, the segmented image 318 includes five regions 320. In some embodiments, the original item image 304 is segmented into the plurality of regions 320 based on a segmentation score. In further embodiments, an elbow method may be utilized to determine the number of regions 320 the original item image 304 is to be segmented into. An elbow method is a known technique generally utilized to determine an optimal number of clusters based on a visual point of change in slope on a graph. In some embodiments, a point on the graph in which a change in slope from one point to the next is most drastic may be chosen as the optimal number of clusters. In some aspects, the segmentation score may include a Calinksi Harabasz Score. The Calinski Harabasz Score, also referred to as the Variance Ratio Criterion, may be used to validate clustering results (that is, to validate the quality of the separation of the pixels belonging to different clusters or segments or regions). Alternatively or in addition, the segmentation score may include one or more Silhouette Score, Davies-Bouldin Index, Adjusted Rand Index, and Mutual Information, to name a few. In the present example, during utilization of the elbow method, a number of regions 320 to segment the original item image 304 into may be variable (e.g., on an x-axis) and the Calinski Harabasz Score may be dependent on the number of regions 320 (e.g., on a y-axis). When utilized together, the elbow method and the Calinski Harabasz Score may assist in determining an optimal number of regions to segment the original item image 304 into. It is generally contemplated that the elbow method may be used in conjunction with or separate from the segmentation score.

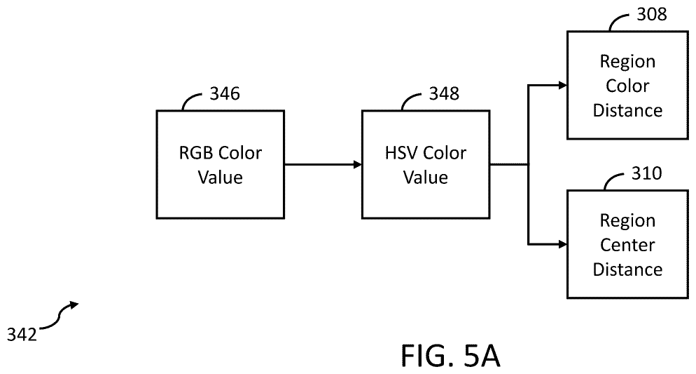

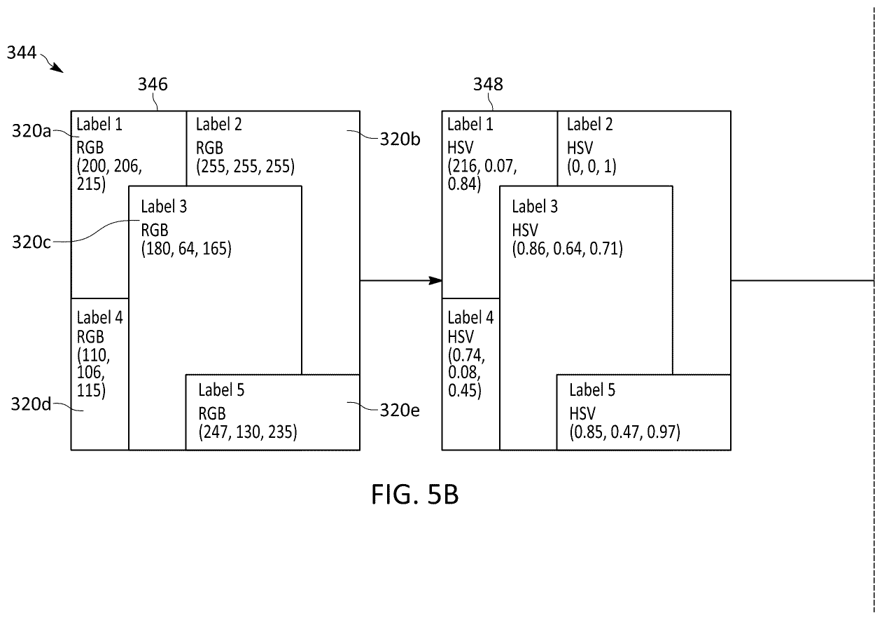

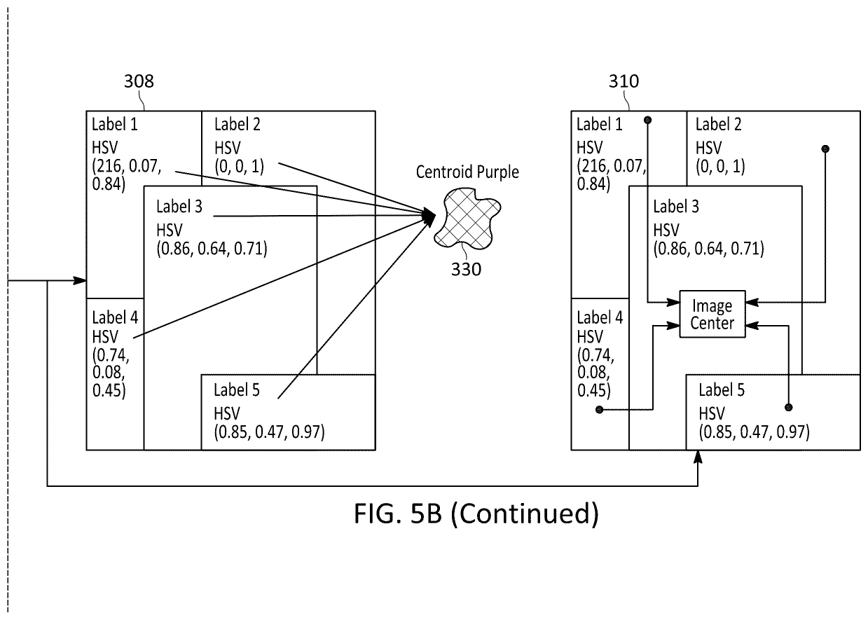

In some embodiments, after the original item image 304 is segmented into the segmented image 318, a region color value 322 is determined for each of the regions 320. As shown in FIG. 3B, the region color value 322 may be in the form of a hue saturation value (HSV) (such as the HSV Color Value 348 of FIG. 5A). In some embodiments, the region color value 322 may be in the form of Red Green Blue (RGB) values, Red Green Blue Alpha (RGBA) values, hexadecimal values, hexadecimal with transparency values, Hue Saturation Lightness (HSL) values, Hue Saturation Lightness Alpha (HSLA) values, Cyan Magenta Yellow Black (CMYK) values, HSV values, and so forth. In the example 302, a first region 320a is labeled “Label 1” and has a region color value 322 with an HSV value of (216, 0.07, 0.84), a second region 320b is labeled “Label 2” and has a region color value 322 with an HSV value of (0, 0, 1), a third region 320c is labeled “Label 3” and has a region color value 322 with an HSV value of (0.86, 0.64, 0.71), a fourth region 320d is labeled “Label 4” and has a region color value 322 with an HSV value of (0.74, 0.08, 0.45), and a fifth region 320e is labeled “Label 5” and has a region color value 322 with an HSV value of (0.85, 0.47, 0.97).

In some embodiments, to determine the similarity between the region color value 322 of a region 320 and an item color 330 of the item in the original item image 304, a region color distance 308 is calculated for each of the regions 320. Generally, the item color 330 is associated with the item in the original item image 304 and is provided from data stored in a database associated with the item and consequently associated with the original item image 304. The item color 330 may be the color 112 stored in the database 106 as described with reference to FIG. 1. In the present example, the item color 330 is labeled “centroid purple”. In some embodiments, the item color 330 is associated with an item color value which may be the same type of color value as the region color value 322 and/or translatable to the type of color value of the region color value 322 (e.g., RGB, HSV, HSL, etc.). A region 320 may be identified as being similar in color to the item color 330 based on the region color distance 308 between the item color 330 and the region color value 322. In some aspects, the identified region 320 is identified based on the shortest region color distance 308 between the item color 330 and the region color value 322 of each of the regions 320.

In some embodiments, in order to determine how to crop the original item image 304 into the cropped image 312, the region center distance 310 (also referred to herein as a location distance) is calculated for each of the regions 320. Generally, the region center distance 310 is determined by calculating the distance between a region center 324 of a region 320 and an image center 328 of the original item image 304. The region center distance 310 can then be utilized to determine where to center the cropped image 312 during cropping of the original item image 304. As shown in FIG. 3B. the region 320 with a region color value 322 closest to the item color 330 is the third region 320c labeled “Label 3”, and as a result, the cropped image 312 is centered to include the portions of the original item image 304 with the third region 320c “Label 3”.

In some embodiments where a cropped image 312 is generated, a plurality of patches 314 are generated from the cropped image 312. In other words, the resulting patches 314 are segmented from the portion of the original item image 304 which contains the region 320 being identified as having a region color value 322 closest to the item color 330 of the item in the original item image 304. The patches 314 may have any suitable shape and/or size. In some embodiments, the patches 314 are generated such that each patch is uniformly dimensioned, and the number of patches 314 corresponds with the number of patches 314 able to be generated based on the dimensions of the identified region 320. In some embodiments, the patches 314 may be randomly generated based on a predetermined or randomly generated number of patches. In some embodiments, a patch color may be determined for each of the patches 314, and the patch 314 that is more homogeneous and similar in color to the item color 330 relative to the other patches 314 may be selected and assigned as the swatch 316 to associate with the item. In other words, the patch 314 that is most homogenous and most similar in color to the item is chosen as the swatch 316. In some embodiments, the selected or chosen patch 314 is based on homogeneity of a plurality of pixels and on a similarity to the color stored in the database 106 associated with the item relative to other patches of the plurality of patches.

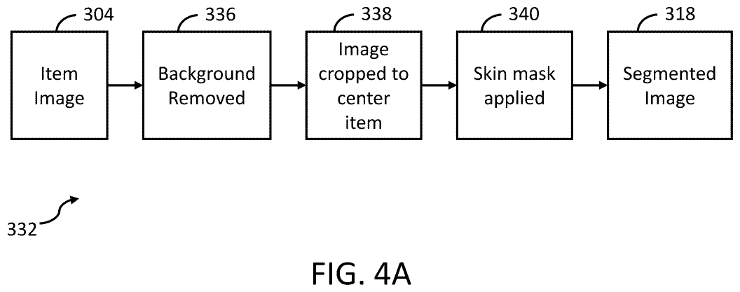

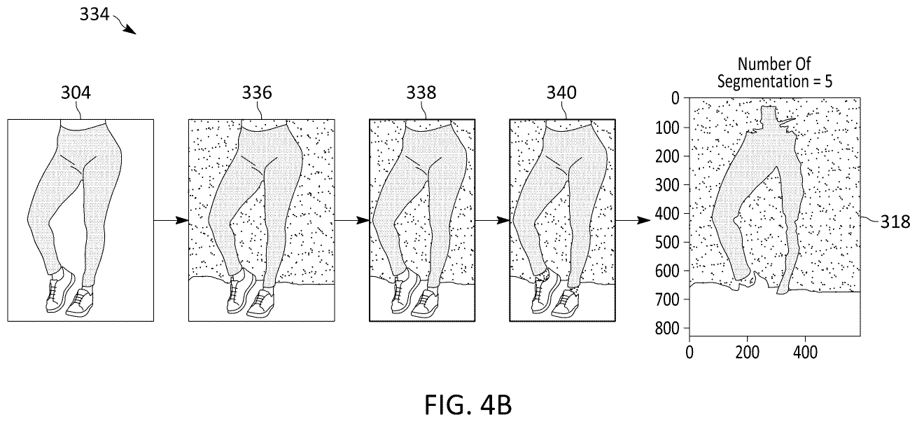

Further referring to FIGS. 4A and 4B, a process 332 of pre-processing the original item image 304 is shown in accordance with some embodiments. In some embodiments, the process 332 is generally contemplated to be part of or utilized with the process 300. In some embodiments, the process 332 may be executed by the system 100. Specifically, the processing resource 102 may perform some or all of the steps of the process 332 described herein. In some aspects, prior to segmenting the original item image 304 into the segmented image 318, various pre-processing steps may be performed, including a step 336 to remove a background of the original item image 304, a step 338 to crop the original item image 304 in order to center the item in the image, and/or a step 340 of applying a skin mask to remove skin from the image prior to segmentation. While three steps 336, 338, 340 are described, it is generally contemplated that any alternate and/or additional pre-processing steps may be performed on the original item image 304 prior to image segmentation 306.

FIG. 4B demonstrates an example 334 of the process 332 for pre-processing. In some embodiments, the example 334 may be part of the example 302 such that the original item image 304 is the same in each example 302, 334. The original item image 304 of FIG. 3B is shown first to have the background removed in step 336, be cropped to center the item in step 338, and have a skin mask applied in step 340 prior to image segmentation 306 and the generation of the segmented image 318. In some embodiments, the cropping of the image and the centering the item in the image performed in step 338 are performed as separate steps. Steps 336, 338, 340 may be performed in any alternate order and/or combination and with any alternate and/or additional steps.

Further referring to FIGS. 5A and 5B, a process 342 for determining the region color value 322 is shown in accordance with some embodiments. In some embodiments, the process 342 is generally contemplated to be an additional process that may be a part of or utilized with the process 300. In some embodiments, the process 342 may be executed by the system 100. Specifically, the processing resource 102 may perform some or all of the steps of the process 342 described herein. In some embodiments, the region color value 322 is initially an RGB Color Value 346 which is mapped to an HSV Color Value 348. The region color distance 308 may then be determined utilizing the HSV Color Value 348 of the regions 320 from the segmented image 318, and an HSV color value of the item in the original item image 304 (that is, the HSV color value of the stored color associated with the item in the database 106). In other words, the item color 330 may be an HSV color value and, in order to determine the region color distance 308, the color values of the item color 330 and the region color value 322 need to be the same type (i.e., also an HSV color value). Therefore, if the region color value 322 is initially an RGB Color Value 346, the RGB Color Value 346 needs to be mapped to an HSV Color Value 348 to determine the region color distance 308. In some embodiments, the region color distance 308 may be determined solely based on the RGV color values such that mapping of the RGV color values to the corresponding HSV color values may not be required.

FIG. 5B demonstrates an example 344 of the process 342 for determining color values and similarity of region color values 322 to an item color 330. It is generally contemplated that the example 344 may be a part of the example 302 such that the original item image 304 is the same in each example 302, 344. It is understood that the original item image 304 is the same in each example 302, 344, therefore the region 320 labels and associated HSV color values 348 are described herein with reference to FIG. 3B and will not be repeated. In the present embodiment, the RGB Color Value 346 of the first region 320a labeled “Label 1” is (200, 206, 215), the RGB Color Value 346 of the second region 320b labeled “Label 2” is (255, 255, 255), the RGB Color Value 346 of the third region 320c labeled “Label 3” is (180, 64, 165), the RGB Color Value 346 of the fourth region 320d labeled “Label 4” is (110, 106, 115), and the RGB Color Value 346 of the fifth region 320e labeled “Label 5” is (247, 130, 235). While the process 342 demonstrates mapping an RGB Color Value 346 to an HSV Color Value 348, it is generally understood that any alternate types of color values may be mapped to one another to allow a region color distance 308 and a region center distance 310 to be determined.

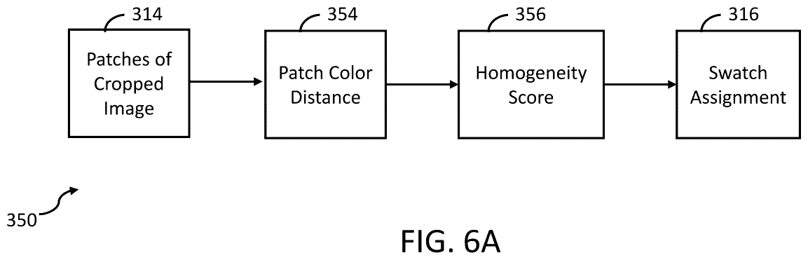

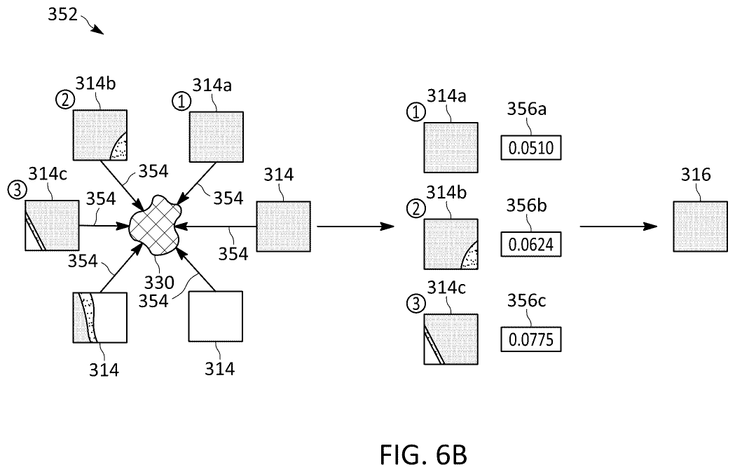

Further referring to FIGS. 6A and 6B, a process 350 for determining which patch 314 of multiple patches 314 is to be selected as the swatch 316. The process 350 is generally contemplated to be an additional process that may be a part of or utilized with the process 300. It is generally contemplated that the process 350 may be executed by the system 100. Specifically, the processing resource 102 may perform some or all of the steps of the process 350 described herein. Generally, after the patches 314 are generated from the cropped image 312, a patch color distance 354 between a color value of each patch 314 and the item color 330 is determined. The color value of each patch 314 may be determined the same or similarly to the determination of the region color value 322 of each region 320. In other words, determining the patch color distance 354 may be the same or similar to determining the region color distance 308. The patch color value may be any suitable type of color value (e.g., RGB, HSV, etc.). In some embodiments, the process 342 or portions thereof may be applied to the patches 314 in determining the patch color distance 354. Once the patch color distance 354 is determined, a homogeneity score 356 of each of the patches 314 may be determined. The homogeneity score 356 may indicate how homogenous a patch is (i.e., uniformity in color or pattern of the patch 314). In some embodiments, a patch 314 that has the smallest patch color distance 354 and that has a homogeneity score 356 indicating high homogeneity of the patch 314 may be selected and assigned as the swatch 316. In some embodiments, a homogeneity score 356 of the selected patch 314 is above a threshold homogeneity score. For example, a patch color distance 354 is determined for each pixel in the patch 314. The patch 314 having the highest number of pixels that has the shortest patch color distance 354, or within a predetermined threshold range of the determined patch color distance 354, is considered as the patch 314 to be assigned as the swatch 316.

FIG. 6B demonstrates an example 352 of the process 350 for determining which patch 314 to select as the swatch 316. It is generally contemplated that the example 352 may be a part of the example 302 such that the original item image 304 is the same in each example 302, 352. As shown, six patches 314 are generated from the cropped image 312, and a patch color distance 354 between each patch 314 and the item color 330 of the item in the original item image 304 is determined. In the present example, a first patch 314a is labeled “1”, a second patch 314b is labeled “2”, and a third patch 314c is labeled “3” are determined to be closest in color to the item color 330 based on the patch color distance 354. A homogeneity score 356 is determined for each of the patches 314a, 314b, 314c. The homogeneity score 356a of the first patch 314a is 0.0510, the homogeneity score 356b of the second patch 314b is 0.0624, and the homogeneity score 356c of the third patch 314c is 0.0775. In the present example, a patch 314 that is more homogenous has a lower homogeneity score 356, and consequently the first patch 314a is selected as the swatch 316. It is generally contemplated, however, that any suitable scoring scale may be used for the homogeneity score 356. Alternatively or in addition to the homogeneity score 356, the Gini Index and/or Entropy may be determined for each of the patches 314a, 314b, 314c.

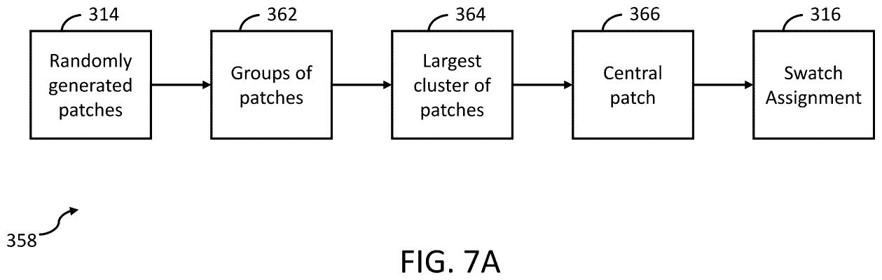

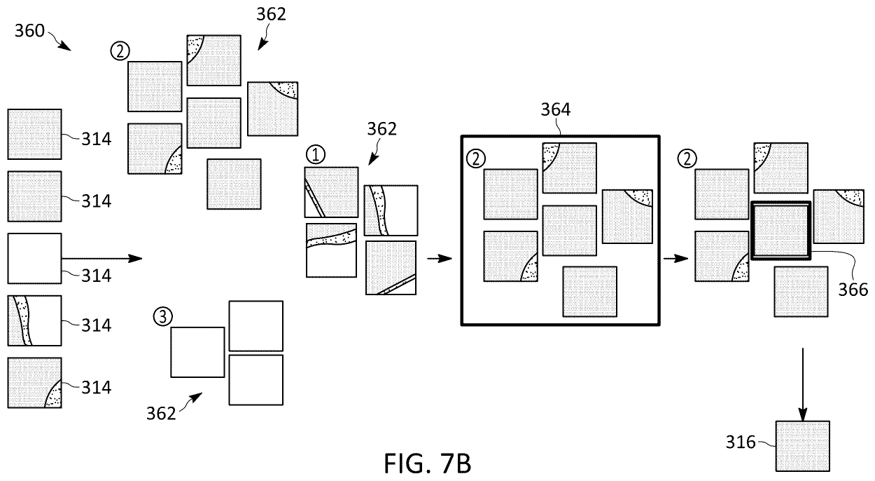

Further referring to FIGS. 7A and 7B, a process 358 for generating a swatch 316 when an item color 330 is not available or not valid is shown in accordance with some embodiments. In some embodiments, it is generally contemplated that the process 358 is a secondary and/or alternate process followed when a swatch 316 is unable to be generated by the process 300. It is generally contemplated that the process 358 may be executed by the system 100. Specifically, the processing resource 102 may perform some or all of the steps of the process 358 described herein. It is generally contemplated that the process 358 may be the same or similar to the alternate swatch generation process 216 described with reference to FIGS. 2A and 2B. During execution of the process 358, the patches 314 are generated randomly from the original item image 304. In some embodiments, after the patches 314 are generated the patches 314 are clustered into one or more groups of patches 362 based on relative color distance of the patches 314 to one another. In some embodiments, the patches 314 are clustered using machine learning such as K-Means. In one form, the clustering is performed by the trained model(s) 118 of the system 100. In some aspects, a group of patches 362 is then selected based on the number of patches 314 within the group of patches 362. In the present embodiment, the largest cluster of patches 364 is chosen from the groups of patches 362. In one form, the central patch 366 within the largest cluster of patches 364 is then selected and assigned as the swatch 316. In some embodiments, the trained model(s) 118 may implement intuitive solution where the trained model(s) 118 is trained to identify a patch to be assigned as the swatch 316 where the patch is taken from an area in the image that is mostly comprise of the actual color of the item (that is, the color closest to the associated color stored for the item) covering the largest area of the image.

FIG. 7B demonstrates an example 360 of the process 358 for an alternative process of swatch generation. It is generally contemplated that the example 360 may be a part of the example 302 such that the original item image 304 is the same in each example 302, 360. As shown, multiple patches 314 are randomly generated from the original item image 304. While five patches 314 are shown initially on the left side of FIG. 7B, it is understood that this is subset of patches 314 representative of the total number of patches 314 generated. Any suitable numbers of patches 314 may be generated and, in some embodiments, an image is uniformly segmented into patches 314 having pre-determined dimensions, and the number of patches 314 generated corresponds with the number of patches 314 able to be generated based on the dimensions of the image. After the patches 314 are generated, three groups of patches 362 are generated. A first group of patches 362 labeled “1” contains four patches 314 having non-uniform color, a second group of patches 362 labeled “2” contains six patches 314 having a primarily uniform purple color, and a third group of patches 362 labeled “3” contains three patches 314 having a primarily uniform white color. In the present example, the largest cluster of patches 364 is the group of patches 362 labeled “2”. The central patch 366 is then chosen from the group of patches 362 labeled “2” and is then assigned to be the swatch 316.

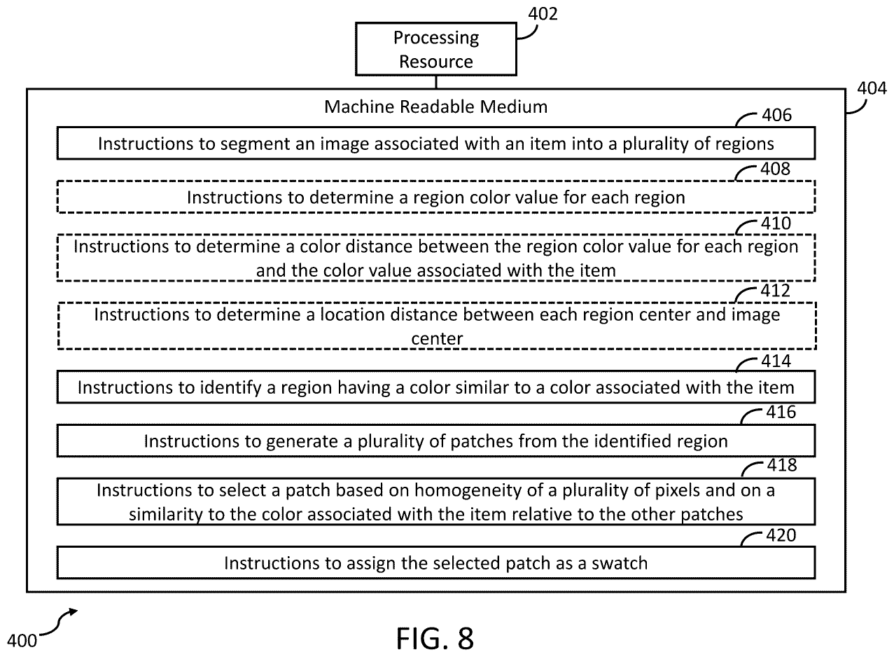

FIG. 8 shows a system 400 in accordance with some embodiments. The system 400 may, in some embodiments, be the system 100 and/or include components thereof. The system 400 generally includes a non-transitory computer-readable medium (e.g., the machine readable medium 404) programmed with computer-executable instructions (e.g., instructions 406, 408, 410, 412, 414, 416, 418, and/or 420) for operating a computing device that includes a processing resource 402 and the non-transitory computer-readable medium (e.g., the machine readable medium 404) bearing the instructions 406, 408, 410, 412, 414, 416, 418, 420 executable by the processing resource 402. In some embodiments, the processing resource 402 retrieves and executes the various instructions in the non-transitory computer readable medium 404. In some embodiments, the processing resource 402 and the non-transitory computer readable medium 404 are separate devices communicationally coupled together. In some embodiments, the processing resource 402 and the non-transitory computer readable medium 404 are integrated into the same device. And in some embodiments, the processing resource 402 and a portion of the non-transitory computer readable medium 404 are in separate devices and a portion are integrated in the same device.

In some embodiments, the instructions 406, 408, 410, 412, 414, 416, 418, 420 when executed by the processing resource 402 implement a method of image processing for swatch generation. The instructions 406, when executed by the processing resource 402, implement a step of segmenting an image associated with an item of a plurality of items into a plurality of regions, where data associated with the plurality of items is stored in a database, the data including one or more colors associated with at least some of the plurality of items. The instructions 408, when executed by the processing resource 402, implement an optional step of determining a region color value for each region (e.g., optional steps are indicated in dashed instruction boxes in FIG. 8). The instructions 410, when executed by the processing resource 402 implement an optional step of determining a color distance between the region color value for each region and a color value associated with the item. The instructions 412, when executed by the processing resource 402, implement an optional step of determining a location distance between a region center of each region and an image center of the image. The instructions 414, when executed by the processing resource 402, implement a step of identifying a region having a color similar to a color associated with the item in the image. Optionally, there may be instructions that when executed by the processing resource 402, implement a step of cropping the identified region from the image. The instructions 416, when executed by the processing resource 402, may implement a step of generating a plurality of patches from the identified region of the image. The instructions 418, when executed by the processing resource 402, implement a step of selecting a patch based on homogeneity of a plurality of pixels and on a similarity to the color stored in the database associated with the item relative to other patches of the plurality of patches. In some embodiments, the step of selecting the patch in instructions 418, may include implementing a step of selecting a patch that is determined to be more homogenous and similar to the color stored in the database relative to other patches of the plurality of patches. The instructions 420, when executed by the processing resource 402, implement a step of assigning the selected patch as the swatch to associate with the item.

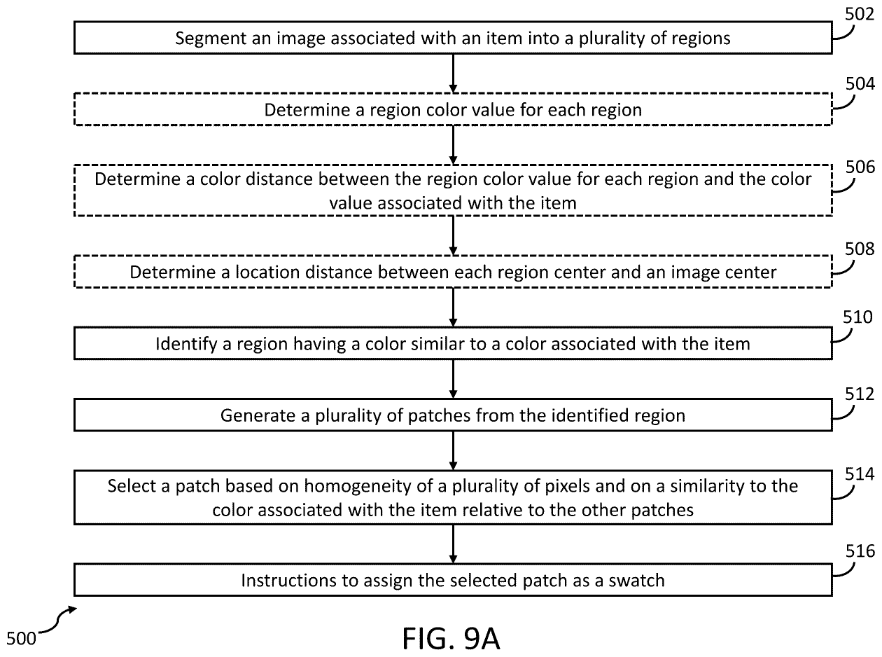

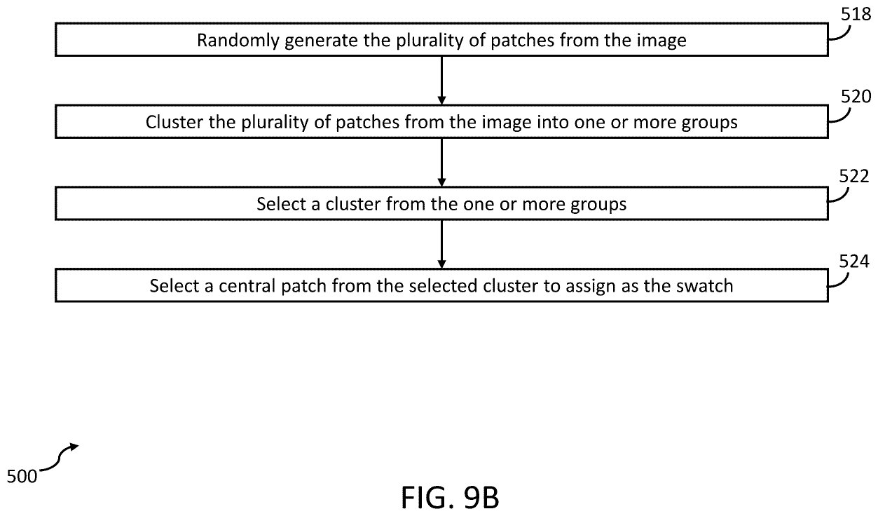

FIGS. 9A and 9B show a method 500 of image processing for swatch generation for items in accordance with some embodiments. It is generally contemplated that the method 500 may be implemented by the systems 100, 400 and/or components of the systems 100, 400, and other systems. In some embodiments, the method 500 may include some and/or all of the steps from processes 200, 300.

Referring to FIG. 9A, at step 502, the method 500 includes segmenting an image associated with an item of a plurality of items into a plurality of regions. Data associated with the plurality of items may be stored in a database, and the data may include one or more colors associated with at least some of the plurality of items. In some embodiments, the image may be segmented into the plurality of regions based on a segmentation score. In some aspects, the segmentation score may be in the form of a Calinski Harabasz Score. In some embodiments, the method 500 includes utilizing an elbow method during segmentation to determine a number of regions to segment the image into. At step 504, the method 500 optionally includes determining a region color value for each region of the plurality of regions (e.g., optional steps are indicated in dashed boxes in FIG. 9A). At step 506, the method 500 optionally includes, determining a color distance between the region color value for each of the plurality of regions and a color value associated with the item. At step 508, the method 500 optionally includes, determining a location distance between a region center of each of the plurality of regions and an image center of the image. At step 510, the method 500 includes identifying a region having a color similar to a color stored in the database associated with the item. In some embodiments, the identified region of the plurality of regions is associated with a color distance (e.g., the shortest color distance of the color distances) between a region color value of the identified region and the color value associated with the item. In some embodiments, the method 500 includes cropping the identified region from the image.

At step 512, the method 500 includes generating a plurality of patches from the identified region of the image. In some embodiments, the plurality of patches may be generated from a cropped identified region of the image. In some embodiments, the method 500 may include determining a patch color value for each of the plurality of patches. In some embodiments, the method 500 may include determining, for each patch of the plurality of patches, a patch distance between the patch color value and a color value of the color associated with the item. At step 514, the method 500 includes selecting a patch of the plurality of patches based on homogeneity of a plurality of pixels and on a similarity to the color stored in the database relative to the other patches of the plurality of patches. In some embodiments, the selection of the patch at step 514 corresponds to selecting a patch of the plurality of patches having a plurality of pixels that are determined to be more homogenous and similar to the color stored in the database relative to the other patches of the plurality of patches. In some embodiments, the selected patch of the plurality of patches is associated with a patch distance (e.g., the shortest patch distance of the patch distances) between a patch color value of the selected patch and the color value associated with the item. In some embodiments, the method 500 may include determining a homogeneity score for each patch of the plurality of patches, and a homogeneity score of the selected patch is above a threshold homogeneity score. At step 516, the method 500 includes assigning the selected patch as a swatch to associate with the item.

Further referring to FIG. 9B, an alternate process for swatch generation of the method 500 is shown in accordance with some embodiments. Generally, the alternate process is followed when a swatch is unable to be extracted while utilizing the steps shown in FIG. 9A and/or when the stored color associated with the item in the database 106 is not a known/recognized color or a null data. At step 518, the method 500 includes randomly generating the plurality of patches from the image. At step 520, the method 500 includes clustering the plurality of patches from the image into one or more groups based on relative color distance of the plurality of patches from one another. In some embodiments, the patches are clustered using machine learning models (e.g., K-Means). At step 522, the method 500 includes selecting a cluster from the one or more groups based on a number of patches in the selected cluster. In some embodiments, the cluster with the largest number of patches is selected. At step 524, the method 500 includes selecting a central patch from the selected cluster to assign as the swatch.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system comprising:
a database storing data associated with a plurality of items, the data including one or more colors associated with at least some of the plurality of items;
a processing resource; and
a machine readable medium storing instructions that, when executed by the processing resource, cause the processing resource to:
segment an image associated with an item of the plurality of items into a plurality of regions;
identify a region of the plurality of regions having a region color similar to a color stored in the database associated with the item;
generate a plurality of patches from the identified region of the image;
select a patch of the plurality of patches based on homogeneity of a plurality of pixels and on a similarity to the color stored in the database associated with the item relative to other patches of the plurality of patches; and
assign the selected patch as a swatch to associate with the item.

2. The system of claim 1, wherein the instructions, when executed by the processing resource, further cause the processing resource, when there is no data stored in the database that corresponds to the color associated with the item, to:
randomly generate the plurality of patches from the image;
cluster the plurality of patches into one or more groups based on relative color distance of the plurality of patches from one another;
select a cluster from the one or more groups based on a number of patches in the selected cluster; and
select a central patch from the selected cluster to assign as the swatch.

3. The system of claim 1, wherein the image is segmented into the plurality of regions based on a segmentation score.

4. The system of claim 3, wherein the instructions, when executed by the processing resource, further cause the processing resource during segmentation of the image to:
utilize an elbow method to determine a number of regions in the plurality of regions, wherein the segmentation score comprises a Calinski Harabasz Score.

5. The system of claim 1, wherein the instructions, when executed by the processing resource, further cause the processing resource during identification of the region to:
determine a region color value for each region of the plurality of regions;
determine a color distance between the region color value for each of the plurality of regions and a color value associated with the item; and
determine a location distance between a region center of each of the plurality of regions and an image center of the image;
wherein the identified region of the plurality of regions is associated with a color distance between a region color value of the identified region and the color value associated with the item.

6. The system of claim 5, wherein the instructions, when executed by the processing resource, further cause the processing resource during the identification of the region to:
determine a hue saturation value (HSV) for each region of the plurality of regions; and
map each HSV to a respective region color value for each region in the plurality of regions.

7. The system of claim 1, wherein the instructions, when executed by the processing resource, further cause the processing resource during selection of the patch to:
determine a patch color value for each patch of the plurality of patches; and
determine, for each patch of the plurality of patches, a patch distance between the patch color value and a color value of the color associated with the item,
wherein the selected patch of the plurality of patches is associated with a patch distance between a patch color value of the selected patch and the color value associated with the item.

8. The system of claim 1, wherein the instructions, when executed by the processing resource, further cause the processing resource to:
crop the identified region from the image, wherein the plurality of patches are generated from the cropped identified region of the image.

9. The system of claim 1, wherein the instructions, when executed by the processing resource, further cause the processing resource to:
pre-process the image by doing at least one of applying a skin mask to the image, removing a background from the image, cropping the image, and centering the item in the image.

10. The system of claim 1, wherein the instructions, when executed by the processing resource, further cause the processing resource during a selection of the selected patch to:
determine a homogeneity score for each patch of the plurality of patches, wherein a homogeneity score of the selected patch is above a threshold homogeneity score.

11. The system of claim 1, wherein the instructions, when executed by the processing resource, further cause the processing resource to output the swatch proximate the item for display on a user device.

12. A method comprising:
segmenting, an image associated with an item of a plurality of items into a plurality of regions, wherein data associated with the plurality of items is stored in a database, the data including one or more colors associated with at least some of the plurality of items;
identifying a region of the plurality of regions having a region color similar to a color stored in the database associated with the item;
generating a plurality of patches from the identified region of the image;
selecting a patch of the plurality of patches based on homogeneity of a plurality of pixels and on a similarity to the color stored in the database associated with the item relative to other patches of the plurality of patches; and
assigning the selected patch as a swatch to associate with the item.

13. The method of claim 12, wherein the image is segmented into the plurality of regions based on a segmentation score.

14. The method of claim 13, further comprising:
during the segmenting of the image, utilizing an elbow method to determine a number of regions in the plurality of regions, wherein the segmentation score comprises a Calinski Harabasz Score.

15. The method of claim 12, further comprising: during the identifying of the region,
determining a region color value for each region of the plurality of regions;
determining a color distance between the region color value for each of the plurality of regions and a color value associated with the item; and
determining a location distance between a region center of each of the plurality of regions and an image center of the image;
wherein the identified region of the plurality of regions is associated with a color distance between a region color value of the identified region and the color value associated with the item.

16. The method of claim 12, further comprising: during the selecting of the patch,
determining a patch color value for each patch of the plurality of patches; and
determining, for each patch of the plurality of patches, a patch distance between the patch color value and a color value of the color associated with the item,
wherein the selected patch of the plurality of patches is associated with a patch distance between a patch color value of the selected patch and the color value associated with the item.

17. The method of claim 12, further comprising:
cropping the identified region from the image, wherein the plurality of patches are generated from the cropped identified region of the image.

18. The method of claim 12, further comprising: during the selecting of the selected patch,
determining a homogeneity score for each patch of the plurality of patches, wherein a homogeneity score of the selected patch is above a threshold homogeneity score.

19. A non-transitory machine readable medium storing instructions for a system that, when executed, cause a processing resource to:
segment an image associated with an item of a plurality of items into a plurality of regions, wherein data associated with the plurality of items is stored in a database, the data including one or more colors associated with at least some of the plurality of items;
identify a region of the plurality of regions having a region color similar to a color stored in the database associated with the item;
generate a plurality of patches from the identified region of the image;
select a patch of the plurality of patches based on homogeneity of a plurality of pixels and on a similarity to the color stored in the database associated with the item relative to other patches of the plurality of patches; and
assign the selected patch as a swatch to associate with the item.

20. The non-transitory machine readable medium of claim 19, wherein the instructions, when executed, further cause the processing resource to:
crop the identified region from the image, wherein the plurality of patches are generated from the cropped identified region of the image.
